(19) United States
(12) Patent Application Publication
(10) Pub. No.: US 2026/0129464 A1
(43) Pub. Date: May 7, 2026

(54) SPECTRUM SHARING SERVICE FOR DISAGGREGATED NETWORK ARCHITECTURE

(71) Applicant: QUALCOMM Incorporated, San Diego, CA (US)

(72) Inventors: Aleksandar DAMNJANOVIC, Del Mar, CA (US); Satashu GOEL, San Diego, CA (US); Yeliz TOKGOZ, San Diego, CA (US)

(21) Appl. No.: 18/940,495

(22) Filed: Nov. 7, 2024

(51) Int. Cl. H04W 16/14; H04B 7/06; H04W 16/28

(52) U.S. Cl. CPC H04W 16/14; H04B 7/0617; H04W 16/28

(57) ABSTRACT

Various aspects of the present disclosure generally relate to wireless communication. In some aspects, a first network node may receive, from a second network node, policy information associated with shared spectrum. The first network node may send, to a third network node, configuration information that indicates one or more parameters for one or more of a distributed unit (DU) or a radio unit (RU) associated with the disaggregated network architecture in accordance with the policy information associated with the shared spectrum. Numerous other aspects are described.

### FIELD OF THE DISCLOSURE

Aspects of the present disclosure generally relate to wireless communication and specifically relate to techniques, apparatuses, and methods associated with a spectrum sharing service for a disaggregated network architecture.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a first network node for wireless communication. The first network node may include one or more memories and one or more processors coupled to the one or more memories. The one or more processors may be configured to receive, from a second network node, policy information associated with shared spectrum. The one or more processors may be configured to send, to a third network node, configuration information that indicates one or more parameters for one or more of a distributed unit (DU) or a radio unit (RU) associated with a disaggregated network architecture in accordance with the policy information associated with the shared spectrum.

Some aspects described herein relate to a first network node for wireless communication. The first network node may include one or more memories and one or more processors coupled to the one or more memories. The one or more processors may be configured to receive, from a second network node, configuration information that indicates one or more parameters in accordance with policy information associated with shared spectrum. The one or more processors may be configured to communicate in the shared spectrum in accordance with the one or more parameters indicated in the configuration information.

Some aspects described herein relate to a method of wireless communication performed by a first network node associated with a disaggregated network architecture. The method may include receiving, from a second network node, policy information associated with shared spectrum. The method may include sending, to a third network node, configuration information that indicates one or more parameters for one or more of a DU or an RU associated with the disaggregated network architecture in accordance with the policy information associated with the shared spectrum.

Some aspects described herein relate to a method of wireless communication performed by a first network node associated with a disaggregated network architecture. The method may include receiving, from a second network node, configuration information that indicates one or more parameters in accordance with policy information associated with shared spectrum. The method may include communicating in the shared spectrum in accordance with the one or more parameters indicated in the configuration information.

Some aspects described herein relate to a non-transitory computer-readable medium that stores a set of instructions for wireless communication by a first network node. The set of instructions, when executed by one or more processors of the first network node, may cause the first network node to receive, from a second network node, policy information associated with shared spectrum. The set of instructions, when executed by one or more processors of the first network node, may cause the first network node to send, to a third network node, configuration information that indicates one or more parameters for one or more of a DU or an RU associated with the disaggregated network architecture in accordance with the policy information associated with the shared spectrum.

Some aspects described herein relate to a non-transitory computer-readable medium that stores a set of instructions for wireless communication by a first network node. The set of instructions, when executed by one or more processors of the first network node, may cause the first network node to receive, from a second network node, configuration information that indicates one or more parameters in accordance with policy information associated with shared spectrum. The set of instructions, when executed by one or more processors of the first network node, may cause the first network node to communicate in the shared spectrum in accordance with the one or more parameters indicated in the configuration information.

Some aspects described herein relate to an apparatus for wireless communication. The apparatus may include means for receiving, from a first network node, policy information associated with shared spectrum. The apparatus may include means for sending, to a second network node, configuration information that indicates one or more parameters for one or more of a DU or an RU associated with a disaggregated network architecture in accordance with the policy information associated with the shared spectrum.

Some aspects described herein relate to an apparatus for wireless communication. The apparatus may include means for receiving, from a first network node, configuration information that indicates one or more parameters in accordance with policy information associated with shared spectrum. The apparatus may include means for communicating in the shared spectrum in accordance with the one or more parameters indicated in the configuration information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example service management and orchestration architecture, in accordance with the present disclosure.

FIG. 4 is a diagram illustrating an example associated with spectrum sharing in a disaggregated network architecture, in accordance with the present disclosure.

FIG. 5 is a diagram illustrating an example architecture associated with a spectrum sharing service for a disaggregated network architecture, in accordance with the present disclosure.

FIG. 6 is a diagram illustrating an example call flow associated with a spectrum sharing service for a disaggregated network architecture, in accordance with the present disclosure.

FIG. 7 is a diagram illustrating an example process performed, for example, at a first network node or an apparatus of a first network node, in accordance with the present disclosure.

FIG. 8 is a diagram illustrating an example process performed, for example, at a first network node or an apparatus of a first network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

To accommodate increasing traffic demands, there have been various efforts to improve spectral efficiency in wireless networks and thereby increase network capacity (e.g., via use of higher order modulations, advanced MIMO antenna technologies, and/or multi-cell coordination techniques, among other examples). Another way to potentially improve network capacity is to expand system bandwidth. However, available spectrum in frequency bands that have traditionally been licensed or otherwise allocated to mobile network operators has become very scarce. Accordingly, various technologies have been developed to enable spectrum sharing, where multiple users or systems (e.g., associated with different wireless networks, wireless network operators, and/or wireless technologies) utilize the same frequency bands. For example, spectrum sharing techniques and technologies may include dynamic spectrum access or dynamic spectrum sharing, where a channel access procedure (e.g., a listen-before-talk (LBT) procedure) is performed to temporarily access unused spectrum and/or transmission parameters are adapted to avoid interference, licensed shared access where licensed or incumbent users share spectrum with secondary users under specific conditions, cooperative spectrum sharing where different users exchange usage information to avoid conflicts, and/or spatial spectrum sharing where advanced antenna technologies such as MIMO and beamforming are used to exploit spatial diversity and allow multiple concurrent transmissions in the same frequency band with minimal interference. However, when multiple users or systems communicate using shared spectrum, one challenge that arises relates to establishing frameworks to support coordination among different users and enable coexistence that protects operations associated with incumbent systems that may be operating in the shared spectrum.

Various aspects relate generally to techniques to facilitate spectrum sharing in a disaggregated network architecture. Some aspects described herein more specifically relate to a disaggregated network architecture that includes one or more disaggregated network nodes and a disaggregated control unit (e.g., a service management and orchestration (SMO) system) that may provide a spectrum sharing service to enforce policies related to the disaggregated network node(s) communicating in shared spectrum (e.g., spectrum shared with one or more other users, such as an incumbent user that holds exclusive rights to the shared spectrum and specifies policies or conditions associated with communication in the shared spectrum). For example, in some aspects, the SMO system may receive information related to the policies or conditions associated with communication in the shared spectrum from an external server (e.g., operated by the incumbent user or another system coordinating spectrum sharing), such as emission limits in certain spatial directions to protect incumbents or minimize interference. Accordingly, the SMO system may then update configuration parameters associated with one or more network nodes to enforce the policies or conditions associated with communication in the shared spectrum. Furthermore, in some aspects, one or more network nodes may compute or collect telemetry information associated with actual communication operations in the shared spectrum, which may be reported to the SMO system and reported to the external server to enable monitoring, management, and/or appropriate policy updates for the spectrum sharing service.

Particular aspects of the subject matter described in this disclosure can be implemented to realize one or more of the following potential advantages. In some examples, the described techniques can be used to increase spectral efficiency and meet growing wireless communication demands by enabling spectrum sharing among multiple users. Furthermore, by providing a framework to define and enforce policies, conditions, and/or parameters associated with one or more disaggregated network nodes communicating in shared spectrum, the described techniques can be used to protect operations associated with incumbent users, define priority levels for different users, minimize interference between different users, and/or otherwise avoid conflicts between different users. Furthermore, by providing a framework to collect and report telemetry information related to actual communication operations in shared spectrum, the described techniques can be used to exchange information related to shared spectrum usage between different users and refine policies or configurations to avoid conflicts.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

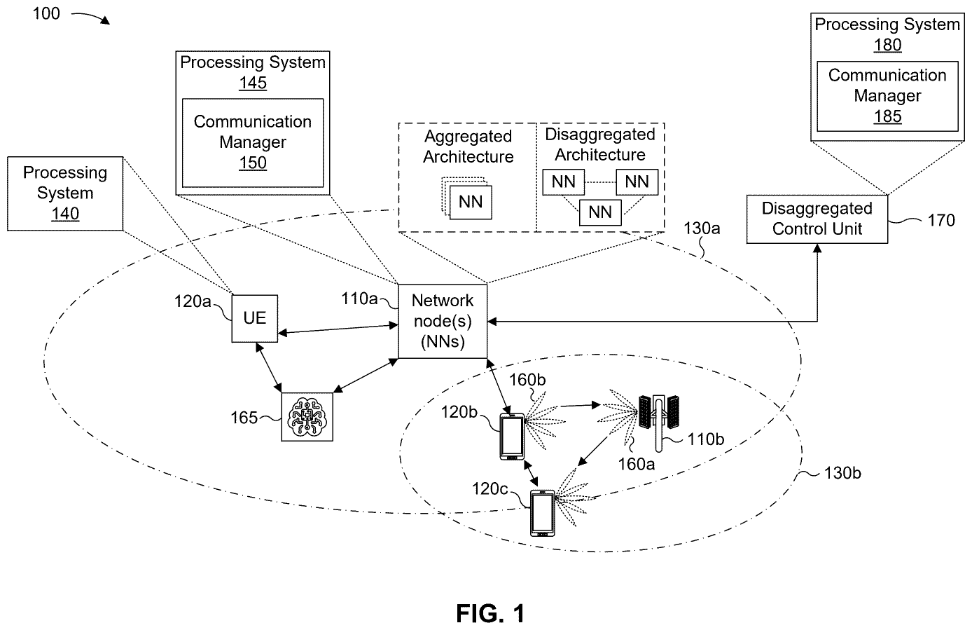

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110. For example, as described herein, a network node 110 may communicate directly with a core network via a backhaul link, or may communicate indirectly with the core network via one or more disaggregated control units 170, such as an SMO system or a RAN intelligent controller (RIC).

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120, a processing system 145 of the network node 110, or a processing system 180 of the disaggregated control unit 170. A processing system (for example, the processing system 140, the processing system 145, and/or the processing system 180) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140, the processing system 145, and the processing system 180 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140, the processing system 145, and the processing system 180 may each include or be coupled with one or more modems (such as a cellular (for example, a 5G or 6G compliant) modem). In some examples, one or more processors of the processing system 140, the processing system 145, and/or the processing system 180 include or implement one or more of the modems. The processing system 140, the processing system 145, and the processing system 180 may also include or be coupled with multiple radios (collectively “the radio”), multiple RF chains, or multiple transceivers, each of which may in turn be coupled with one or more of multiple antennas. In some examples, one or more processors of the processing system 140, the processing system 145, and/or the processing system 180 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120, by the processing system 145 of the network node 110, or by the processing system 180 of the disaggregated control unit 170).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

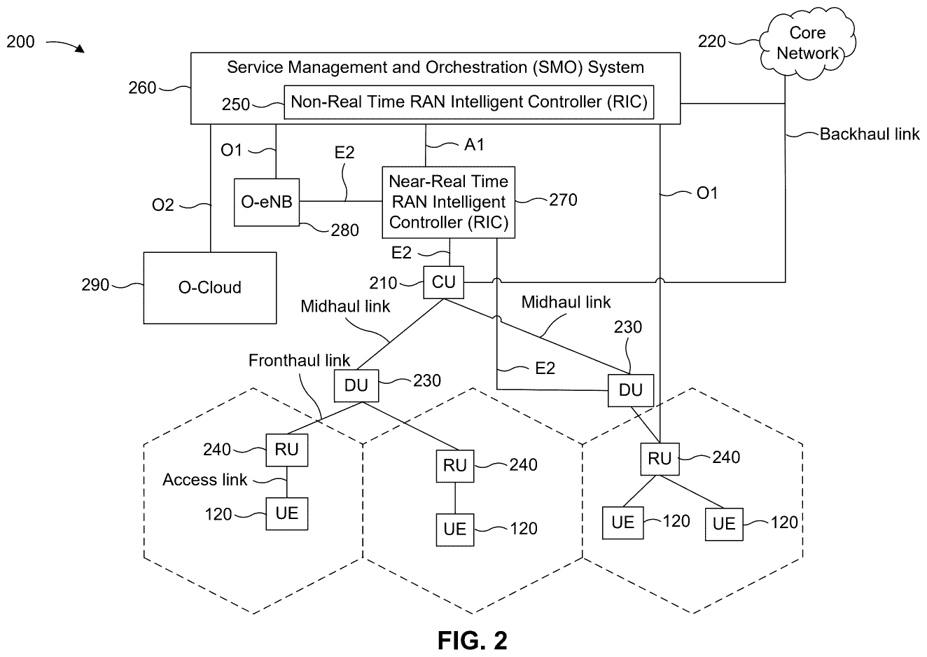

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment. In some examples, the disaggregated control unit 170 may be referred to as a network node or may include a network node.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110, a UE 120, and/or a disaggregated control unit 170). For example, the one or more devices 165 may include a UE 120 (for example, the processing system 140), a network node 110 (for example, the processing system 145), a disaggregated control unit 170 (for example, the processing system 180), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110 or a disaggregated control unit 170). In other examples, a first AI/ML model may be deployed at a UE 120 and a second AI/ML model may be deployed at a network node 110 or a disaggregated control unit 170. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the disaggregated control unit 170 may include a communication manager 185. As described in more detail elsewhere herein, the communication manager 185 may receive, from a second network node, policy information associated with shared spectrum; and send, to a third network node, configuration information that indicates one or more parameters for one or more of a DU or an RU associated with the disaggregated network architecture in accordance with the policy information associated with the shared spectrum. Additionally, or alternatively, the communication manager 185 may perform one or more other operations described herein.

In some aspects, the network node 110 may include a communication manager 150. As described in more detail elsewhere herein, the communication manager 150 may receive, from a second network node, configuration information that indicates one or more parameters in accordance with policy information associated with shared spectrum; and communicate in the shared spectrum in accordance with the one or more parameters indicated in the configuration information. Additionally, or alternatively, the communication manager 150 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RIC 250 associated with an SMO system 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO system 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO system 260 may support RAN deployment and provisioning of non-virtualized and virtualized network elements. For non-virtualized network elements, the SMO system 260 may support the deployment of dedicated physical resources for RAN coverage requirements, which may be managed via an operations and maintenance interface, such as an O1 interface. For virtualized network elements, the SMO system 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO system 260 may communicate with a hardware aspect of a 4G RAN, a 5G NR RAN, and/or a 6G RAN, such as an open eNB (O-eNB) 280, via an O1 interface. Additionally or alternatively, the SMO system 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO system 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO system 260 (such as reconfiguration via an O1 interface) or via creation of RAN management policies (such as A1 interface policies).

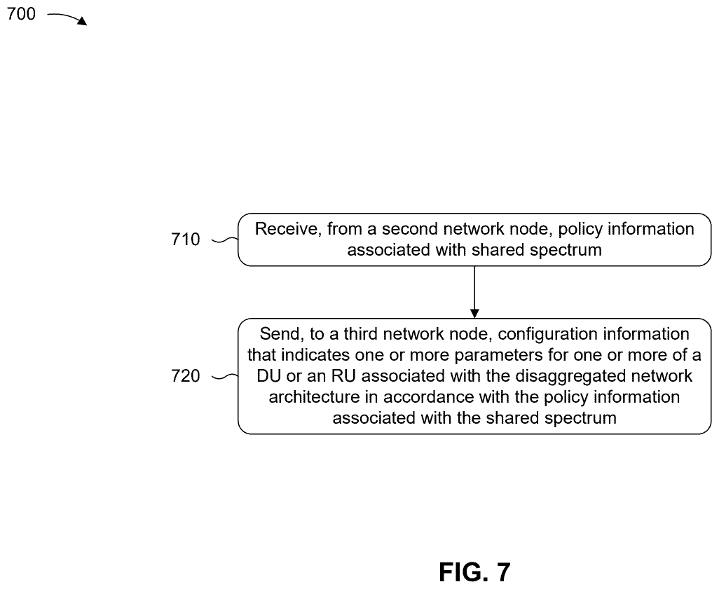

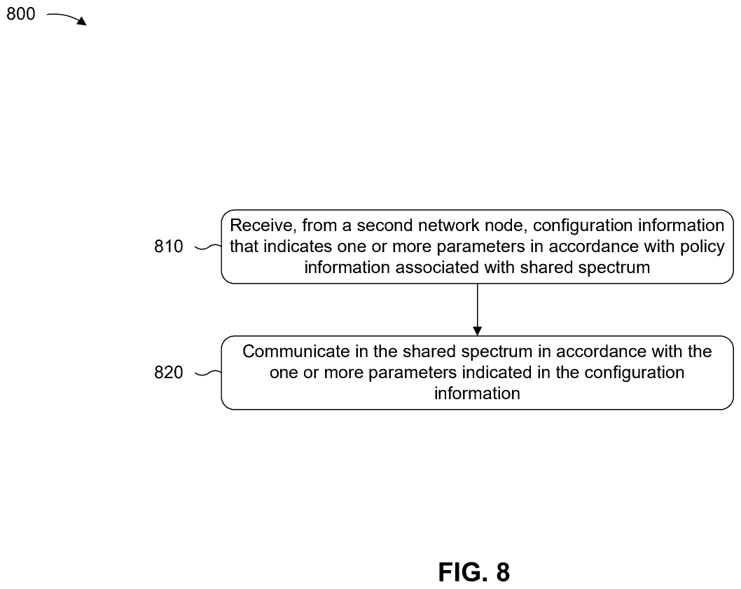

The network node 110, the processing system 145 of the network node 110, the UE 120, the processing system 140 of the UE 120, the disaggregated control unit 170, the processing system 180 of the disaggregated control unit 170, the CU 210, the DU 230, the RU 240, the SMO system 260, the Near-RT RIC 270, or any other component(s) of FIG. 1 and/or FIG. 2 may implement one or more techniques or perform one or more operations associated with a spectrum sharing service for a disaggregated network architecture, as described in more detail elsewhere herein. For example, the processing system 145 of the network node 110, the processing system 140 of the UE 120, the processing system 150 of the disaggregated control unit 170, the CU 210, the DU 230, the RU 240, the SMO system 260, or the Near-RT RIC 270 may perform or direct operations of, for example, process 700 of FIG. 7, process 800 of FIG. 8, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. Memory of the disaggregated control unit 170 may store data and program code (or instructions) for the SMO system 260 or the Near-RT RIC 270. In some examples, the memory of the UE 120, the memory of the network node 110, or the memory of the disaggregated control unit 170 may include a non-transitory computer-readable medium storing a set of instructions for wireless communication. For example, the set of instructions, when executed by one or more processors (for example, of the processing system 140, the processing system 145, or the processing system 180) of the network node 110, the UE 120, the CU 210, the DU 230, the RU 240, the SMO system 260, or the Near-RT RIC 270 may cause the one or more processors to perform process 700 of FIG. 7, process 800 of FIG. 8, or other processes as described herein. In some examples, executing instructions may include running the instructions, converting the instructions, compiling the instructions, and/or interpreting the instructions, among other examples.

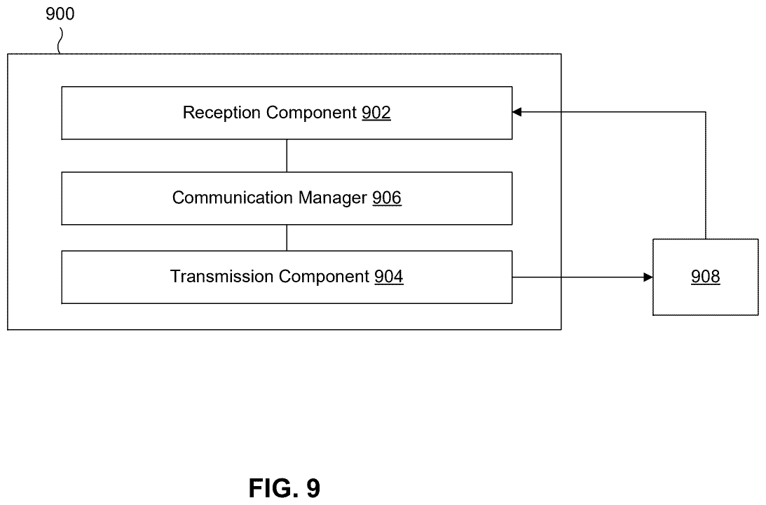

In some aspects, the SMO system 260 includes means for receiving, from a first network node, policy information associated with shared spectrum; and/or means for sending, to a second network node, configuration information that indicates one or more parameters for one or more of a DU 230 or an RU 240 associated with the disaggregated network architecture in accordance with the policy information associated with the shared spectrum. The means for the SMO system 260 to perform operations described herein may include, for example, one or more of communication manager 185, processing system 180, a radio, one or more RF chains, one or more transceivers, one or more antennas, one or more modems, a reception component (for example, reception component 902 depicted and described in connection with FIG. 9), and/or a transmission component (for example, transmission component 904 depicted and described in connection with FIG. 9), among other examples.

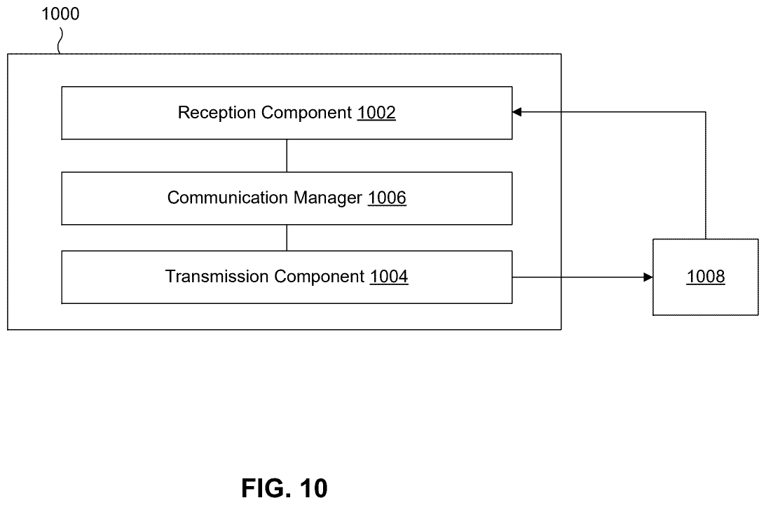

In some aspects, a first network node 110 (e.g., a DU 230 or RU 240) includes means for receiving, from a second network node (e.g., the SMO system 260), configuration information that indicates one or more parameters in accordance with policy information associated with shared spectrum; and/or means for communicating in the shared spectrum in accordance with the one or more parameters indicated in the configuration information. The means for the first network node 110 to perform operations described herein may include, for example, one or more of communication manager 150, processing system 145, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

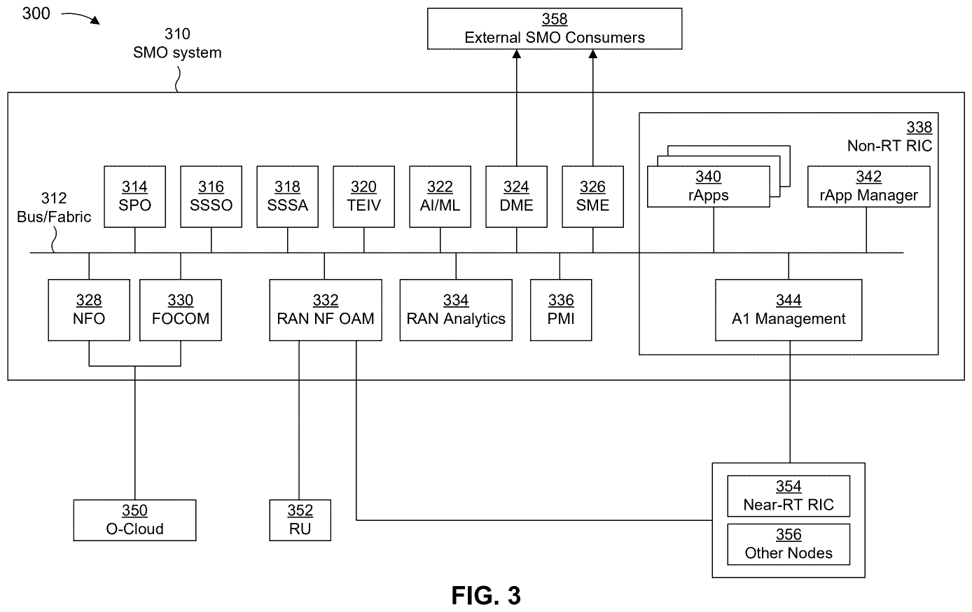

FIG. 3 is a diagram illustrating an example SMO architecture 300, in accordance with the present disclosure. As shown in FIG. 3, SMO architecture 300 may include a SMO system 310 that may interface with an O-Cloud platform 350 or another suitable cloud computing platform, one or more RUs 352, a Near-RT RIC 354, one or more network nodes 356 (e.g., one or more CUs, DUs, or RUs), and/or one or more external SMO consumers 358 (e.g., external entities that consume services provided by the SMO system 310). Devices and/or components of SMO architecture 300 may interconnect via wired connections, wireless connections, or a combination thereof.

In some aspects, the SMO architecture 300 may include an example functional architecture in which systems and/or methods described herein may be implemented. For example, the SMO architecture 300 may be implemented in a disaggregated network architecture, such as an O-RAN. Although the example SMO architecture 300 is a service-based architecture, in some aspects, the SMO architecture 300 may be implemented as a reference-point architecture and/or another suitable architecture.

As shown in FIG. 3, the SMO system 310 may include various functional elements that enable SMO services. For example, as shown, the functional elements may enable a software package onboarding (SPO) service 314, a service and subnet slice orchestration (SSSO) service 316, a service and subnet slice assurance (SSSA) service 318, a topology exposure and inventory (TEIV) service 320, an AI/ML workflow service 322, a data management and exposure (DME) service 324, a service management and exposure (SME) service 326, a network function orchestrator (NFO) service 328, a federated O-Cloud orchestration and management (FOCOM) service 330, a RAN network function (NF) operations, maintenance, and administration (OAM) service 332, a RAN analytics service 334, and a policy management and information (PMI) service 336. In addition, the SMO system 310 includes a Non-RT RIC 338, which may include one or more rApps 340, an rApp management service 342, and an A1 management service 344. The functional elements may be communicatively connected via a message bus or fabric 312. The functional elements or services shown in FIG. 3 may each be implemented on one or more devices associated with a wireless telecommunications system, such as the wireless communication network 100 shown in FIG. 1 or the disaggregated network node architecture 200 shown in FIG. 2. In some aspects, one or more functional elements or services may be implemented on physical devices, such as an access point, a base station, a server, and/or a gateway, and/or may be implemented on a computing device of a cloud computing environment.

The SPO service 314 may provide support for onboarding software packages such as one or more network functions, rApps 340, and/or xApps (not shown in FIG. 3). The SPO service 314 may expose capabilities for ingesting software packages into the SMO system 310, verifying security of the software packages (e.g., performing integrity protection such as verifying vendor signatures), validating software packages to ensure that formats and contents can be understood by the SMO system 310, extracting software package artifacts into appropriate catalogs, and/or storing software images into appropriate repositories.

The SSSO service 316 may enable zero-touch automation for managing the disaggregated network architecture by autonomously coordinating service execution. For example, in some aspects, the SSSO service 316 may automate orchestration for one or more network functions and associated management to correlate, sequence, and coordinate individual actions performed using other SMO services. For example, the SSSO service 316 may provide automation that enables correlation, sequencing, and timing for the appropriate actions, such as coordinating orchestration for one or more network functions, coordinating orchestration for RAN service requests, decomposing RAN service requests into network function constituents, selecting a suitable transport network that fulfills end-to-end service requirements and characteristics (e.g., service latency or throughput), and/or processing service requests received from upper layer service orchestrators and to perform actions to fulfill the service requests in a RAN management domain, among other examples.

The SSSA service 318 may provide services to sustain assurance levels set for one or more end-to-end services, or for one or more network function instances that are managed and orchestrated by the SMO system 310. For example, in some aspects, the SSSA service 318 may collect, consolidate, and detect data related to an E2E service or network function level assurance falling below an assurance level, such that subsequent remedial actions can be taken. The SSSA service 318 may implement closed-loop automation, where the SSSA service 318 monitors and/or observes data relevant to assessing the current end-to-end service and network function assurance levels, analyzes the observed data to determine whether the end-to-end service and network function assurance levels are satisfied, and executes one or more remedial actions (e.g., configuration changes, scaling, or connectivity changes, among other examples) when the end-to-end service and network function assurance levels are not satisfied in collaboration with other services in the SMO system 310.

The TEIV service 320 may maintain information related to a topology and an inventory associated with the disaggregated network architecture to enable efficient operation and maintenance and provide a global view of resources associated with the disaggregated network architecture (e.g., network functions, subnet slices, cloud resources, radio resources, and/or transport resources). In this way, the TEIV service 320 may enable use cases such as providing a network view of available RAN, cloud, and/or transport resources, identifying available or impacted CU, DU, and/or RU instances associated with one or more faults or other events, and/or discovering, allocating, and/or deallocating cloud resources to an instance of the O-Cloud platform 350.

The AI/ML workflow service 322 may provide services to manage AI/ML capabilities to support one or more operations associated with the SMO system 310. For example, in some aspects, the AI/ML workflow service 322 may provide AI/ML training services, AI/ML model management and exposure services, AI/ML model registration and/or deregistration services, AI/ML model discovery services, AI/ML model change subscription services, AI/ML model storage services, AI/ML model training capability registration and/or deregistration services, AI/ML model retrieval services, and/or AI/ML model performance monitoring services.

The DME service 324 may provide capabilities to allow one or more consumers (e.g., the external SMO consumers 358 and/or consumers within the SMO system 310) to discover data types and/or consume data collected or provided to the DME service 324. Furthermore, the DME service 324 may allow producers within the SMO system 310 to register data types and to produce data for collection by the DME service 324. In the decomposed service-based architecture shown in FIG. 3, the DME service 324 can handle any SMO service data types, whereby any SMO service within the SMO system 310 can be a producer of data that is consumed by the DME service 324 or a consumer of data that is produced by the DME service 324.

The SME service 326 may provide services to manage and expose services associated with the rApps 340 and/or any other entity within the SMO system 310. For example, in the decomposed service-based architecture shown in FIG. 3, the SME service 326 can provide a generic SMO service, handling service management and exposure for any SMO service(s) within the SMO system 310. The SME service 326 may provide one or more SMO capabilities that support all SMO services, such as SMO service registration, SMO service discovery, authentication and authorization to access an SMO service, communication support between SMO service producers and SMO service consumers, bootstrapping new SMO services, and/or monitoring SMO service heartbeats, among other examples.

The NFO service 328 and the FOCOM service 330 may provide services to manage and orchestrate resources associated with the O-Cloud platform 350. For example, in some aspects, the NFO service 328 may orchestrate the resources associated with the O-Cloud platform 350, which may be used to deploy network functions that constitute one or more cloudified network functions. For example, the orchestration provided by the NFO service 328 may support initial software deployment and any subsequent lifecycle management actions necessary on respective network function deployment instances, such as healing, updates, scaling, software upgrades, and/or termination, among other examples. Furthermore, the FOCOM service 330 may have capabilities to manage the resources associated with the O-Cloud platform 350. For example, the management capabilities provided by the FOCOM service 330 may include managing infrastructure resources associated with the O-Cloud platform 350 and managing abstracted resources and deployment management services (e.g., managing software that is deployed to provide virtualization technologies such as containers or virtual machines). Additionally, or alternatively, the FOCOM service 330 may have capabilities to maintain infrastructure data associated with the O-Cloud platform 350 (e.g., using the TEIV service 320), monitor the infrastructure associated with the O-Cloud platform 350, provision the infrastructure associated with the O-Cloud platform 350, provide software management for the infrastructure associated with the O-Cloud platform 350, and/or provide lifecycle management for the infrastructure associated with the O-Cloud platform 350, among other examples.

The RAN NF OAM service 332 may manage various network functions associated with a disaggregated network architecture, including one or more RUs 352 that may be managed via a fronthaul M-plane interface, and the Near-RT RIC 354 and/or the other network nodes 356 that may be managed via an O1 interface. In some aspects, the RAN NF OAM service 332 may collect and provide different RAN management data types, including performance data, alarm data, configuration management data, fault management data, policy management data, tracing data, and/or logging data, among other examples. Accordingly, the RAN NF OAM service 332 may collect and provide RAN management data to enable various intelligent use cases for one or more network function instances, such as performance assurance (e.g., monitoring real-time performance data and enabling consumers within the SMO system 310 to detect issues in advance), fault supervision (e.g., providing alarms to consumers within the SMO system 310 and/or allowing consumers to clear or acknowledge alarms), and/or configuration management (e.g., to support creating, deleting, modifying, and/or querying one or more network functions).

The RAN analytics service 334 may consume data and services produced within the SMO system 310, and may then process and analyze the data using internal logic and algorithms to produce RAN analytics outputs (e.g., RAN traffic predictions or statistics, such as UE mobility predictions, and recommendations related to RAN management, among other examples). In some aspects, the RAN analytics service 334 may register with the DME service 324 to indicate data types associated with the RAN analytics service 334 and/or the RAN management analytics produced by the RAN analytics service 334. In this way, the RAN analytics data may be discovered by interested consumers within the SMO system 310 and/or by the external SMO consumers 358 via the DME service 324.

The PMI service 336 may support policy-driven decision processes controlled by the SMO system 310. For example, as described herein, a policy may generally include one or more rules, guidelines, and/or conditions that govern the behavior and/or actions associated with resources and/or services in the disaggregated network architecture. Policies may be used to automate various aspects of network resources and services, and to ensure that the network resources and services operate in accordance with defined rules and objectives. Policies can be expressed in a structured format that defines the scope, objectives, and conditional statements or constraints. Accordingly, the PMI service 336 may fulfill a policy administration point (PAP) role to provision (e.g., create, update, delete, and/or obtain) policies. In this way, the PMI service 336 may decouple policy management (the PAP role) from other services and/or entities (e.g., within or outside the SMO system 310) that fulfill a policy decision point (PDP) role to determine where in a decision process a certain policy can be applied and/or a policy enforcement point (PEP) role to execute actions derived from one or more policies. For example, the PMI service 336 may have capabilities to register and deregister policy types (e.g., resource management or lifecycle management policies), capabilities to discover and query policy types, capabilities to create, query/read, update, and/or delete policies, capabilities to discover policies, capabilities to determine a policy status, and/or capabilities to enable subscriptions and provide notifications for events such as policy changes related to policies and/or policy types.

The Non-RT RIC 338 may include or may implement a logical function that enables deployment of one or more rApps 340 (e.g., non-real-time applications that execute at timescales greater than one second, such as several seconds, minutes, hours, or the like) that may provide non-real-time control and optimization of RAN elements and resources, AI/ML workflows including model training and updates, and/or policy-based guidance of applications and/or features in the Near-RT RIC 354. Similarly, the Near-RT RIC 354 may include or may implement a logical function that enables deployment of one or more xApps (e.g., real-time or near real-time applications that execute at timescales less than one second) to provide real-time or near real-time control and optimization for the disaggregated network architecture. In addition, as further shown, the Non-RT RIC 338 may include an rApp management service 342 to provide management services to support one or more rApps 340. For example, the rApp management service 342 may be configured to manage configuration settings, performance reporting, fault management or fault reporting capabilities, logging services, and/or software lifecycle services associated with one or more rApps 340. In addition, the Non-RT RIC 338 may include an A1 management service 344 that enables communication between the rApps 340 and one or more other components, such as the Near-RT RIC 354 and/or the other network nodes 356, via an A1 interface.

The bus/fabric 312 may be a logical and/or physical communication structure for communication among the functional elements. Accordingly, the bus/fabric 312 may permit communication between two or more functional elements, whether logically (e.g., using one or more application programming interfaces (APIs)) and/or physically (e.g., using one or more wired and/or wireless connections).

As indicated above, FIG. 3 is provided as an example. Other examples may differ from what is described with regard to FIG. 3. For example, the number and arrangement of devices shown in FIG. 3 are provided as an example. In practice, there may be additional devices, fewer devices, different devices, or differently arranged devices networks than shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of SMO architecture 300 may perform one or more functions described as being performed by another set of devices.

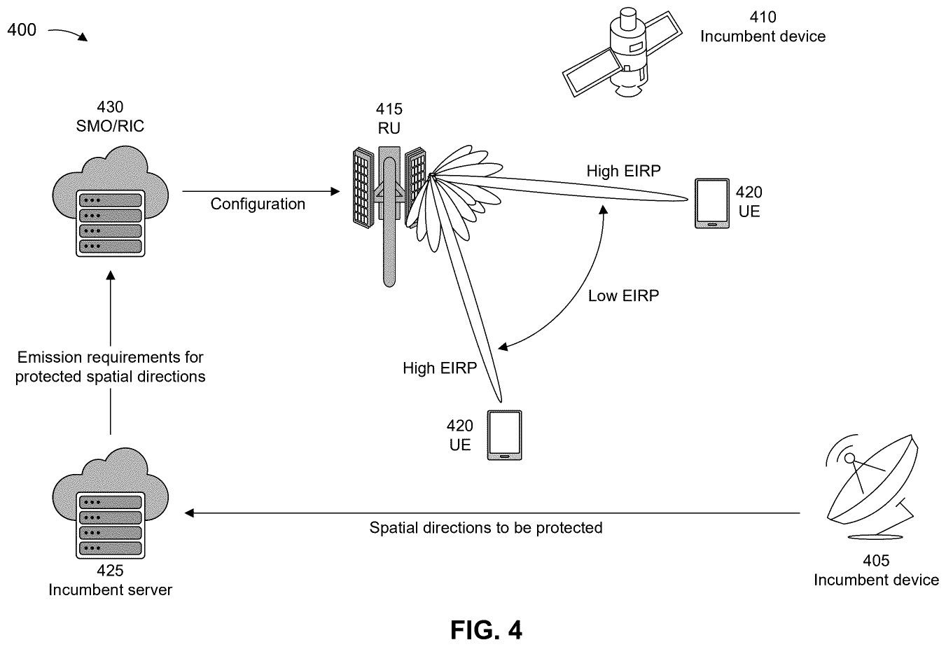

FIG. 4 is a diagram illustrating an example 400 associated with spectrum sharing in a disaggregated network architecture, in accordance with the present disclosure. More particularly, to accommodate increasing traffic demands due to increasing numbers of smartphones, IoT devices, military and public safety radios, wearable devices, smart vehicles, and other devices, there have been various efforts to improve spectral efficiency in wireless networks and thereby increase network capacity (e.g., via use of higher order modulations, advanced MIMO antenna technologies, and/or multi-cell coordination techniques, among other examples). Another way to potentially improve network capacity is to expand system bandwidth. However, available spectrum in frequency bands that have traditionally been licensed or otherwise allocated to mobile network operators has become very scarce.

Accordingly, various technologies have been developed to enable spectrum sharing, where multiple users or systems (e.g., associated with different wireless networks, wireless network operators, and/or wireless technologies) utilize the same frequency bands. For example, spectrum sharing techniques and technologies may include dynamic spectrum access or dynamic spectrum sharing, where a channel access procedure (e.g., an LBT procedure) is performed to temporarily access unused spectrum and/or transmission parameters are adapted to avoid interference, licensed shared access where licensed or incumbent users share spectrum with secondary users under specific conditions, cooperative spectrum sharing where different users exchange usage information to avoid conflicts, and/or spatial spectrum sharing where advanced antenna technologies such as MIMO and beamforming are used to exploit spatial diversity and allow multiple concurrent transmissions in the same frequency band with minimal interference. However, when multiple users or systems communicate using shared spectrum, one challenge that arises relates to establishing frameworks to support coordination among different users and enable coexistence that protects operations associated with incumbent systems that may be operating in the shared spectrum.

For example, FIG. 4 illustrates an example spectrum sharing scenario where an incumbent user that has exclusive or licensed access to certain frequency spectrum specifies one or more policies or conditions to share the frequency spectrum with a secondary user (e.g., a mobile network operator). For example, as shown in FIG. 4, the incumbent user may operate a network deployment that includes one or more terrestrial incumbent devices 405 and one or more non-terrestrial incumbent devices 410 that communicate in the shared spectrum. For example, FIG. 4 illustrates a terrestrial incumbent device 405 corresponding to an Earth stationed receiver, although the terrestrial incumbent device 405 may be or may include any suitable terrestrial network node that can transmit and/or receive wireless signals in the shared spectrum. Furthermore, FIG. 4 illustrates a non-terrestrial incumbent device 410 corresponding to a satellite receiver, although the non-terrestrial incumbent device 410 may be or may include any suitable non-terrestrial network node that can transmit and/or receive wireless signals in the shared spectrum. In some examples, such as the example 400 in FIG. 4 where the incumbent devices 405 and 410 may be deployed to receive wireless signals in specific spatial directions, secondary users operating in the shared spectrum may be permitted to communicate in other spatial directions in a manner that protects operations associated with the incumbent user.

For example, as shown in FIG. 4, a secondary user may operate an RU 415 (or another network node with wireless communication capabilities), which may be equipped with an active antenna system (AAS), beamforming hardware, and/or other capabilities to intelligently focus energy in desired spatial directions in order to protect operations associated with the incumbent user. For example, as shown in FIG. 4, the RU 415 may be configured to transmit wireless signals in the spectrum shared with the incumbent user in one or more spatial directions with a high effective isotropic radiated power (EIRP) (e.g., measured according to a total radiated power from a transmitter multiplied by the numerical directivity of the transmitter in a direction of a receiver, according to the power delivered to the antenna times the antenna numerical gain, or according to another metric). For example, the incumbent user may permit transmissions with a high EIRP in spatial directions that are unused by the incumbent devices 405 and 410, and may specify a low EIRP for transmissions in spatial directions that are used by the incumbent devices 405 and 410. In this way, by intelligently focusing energy in spatial directions where a high EIRP is permitted, the RU 415 may communicate with one or more UEs 420 or other devices located in such directions. Furthermore, by limiting the energy that is emitted in spatial directions subject to a low EIRP constraint, the RU 415 may protect the incumbent devices 405 and 410 in an azimuthal plane (e.g., based on a position or angle of the incumbent devices 405 and 410 around the horizon) and/or in an elevation plane (e.g., based on a position or angle of the incumbent devices 405 and 410 above the horizon). Although the spectrum sharing techniques described herein relate to spatial spectrum sharing, similar concepts may be applied to enable spectrum sharing in a frequency domain (e.g., where the incumbent devices 405 and 410 and the RU 415 communicate using different frequency bands within the shared spectrum) and/or a time domain (e.g., where the incumbent devices 405 and 410 and the RU 415 use the shared spectrum at different times).

Accordingly, some aspects described herein relate to techniques to enable coordination between a server 425 or portal (e.g., operated by an incumbent user or another entity coordinating shared spectrum access) and a disaggregated control unit 430 (e.g., shown as an SMO system and/or RIC) to facilitate spectrum sharing in a disaggregated network architecture. For example, as described herein, the disaggregated control unit 430 may host or provide a spectrum sharing service that can enforce policies related to the RU 415 and/or other disaggregated network nodes communicating in shared spectrum (e.g., an incumbent user that holds exclusive rights to the shared spectrum and specifies policies or conditions associated with communication in the shared spectrum, although the techniques described herein can be applied to any spectrum sharing use case, such as communication using unlicensed spectrum). For example, in some aspects, the disaggregated control unit 430 may receive information related to the policies or conditions associated with communication in the shared spectrum from the server 425 (e.g., operated by the incumbent user or another system coordinating spectrum sharing), such as emission limits in a spatial domain, a time domain, and/or a frequency domain, to protect incumbents or otherwise minimize interference and/or conflicts among users communicating in the shared spectrum. Accordingly, the disaggregated control unit 430 may update configuration parameters associated with one or more network nodes to enforce the policies or conditions associated with communication in the shared spectrum. Furthermore, in some aspects, one or more network nodes may compute or collect telemetry information associated with actual communication operations in the shared spectrum, which may be reported to the disaggregated control unit 430 and to the server 425 to enable monitoring, management, and/or policy updates for the spectrum sharing service.

As indicated above, FIG. 4 is provided as an example. Other examples may differ from what is described with respect to FIG. 4.

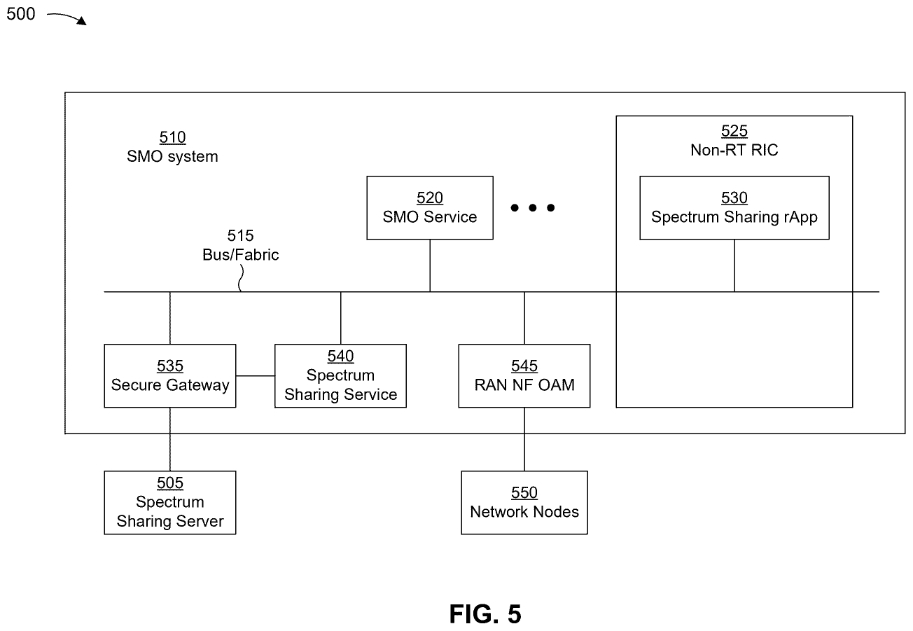

FIG. 5 is a diagram illustrating an example architecture 500 associated with a spectrum sharing service for a disaggregated network architecture, in accordance with the present disclosure. As shown in FIG. 5, example 500 includes communication between an SMO system 510 and a spectrum sharing server 505, and communication between the SMO system 510 and one or more network nodes 550. In some aspects, the SMO system 510 may correspond to a disaggregated control unit or SMO system described elsewhere herein, such as the disaggregated control unit 170, the SMO system 260, the SMO system 310, and/or the disaggregated control unit 430. In some aspects, the SMO system 510 may communicate with the spectrum sharing server 505 using any suitable wired or wireless interface, and may communicate with the one or more network nodes 550 via any suitable backhaul, midhaul, and/or fronthaul interface (e.g., an O1 interface or an open fronthaul M-plane interface, among other examples).

As shown in FIG. 5, the SMO system 510 may include one or more SMO services 520 that may provide one or more services or functions described herein. For example, in some aspects, the SMO services 520 may correspond to and/or provide one or more services or functions associated with the SPO service 314, the SSSO service 316, the SSSA service 318, the TEIV service 320, the AI/ML workflow service 322, the DME service 324, the SME service 326, the NFO service 328, the FOCOM service 330, the RAN analytics service 334, and/or the PMI service 336 described in more detail above in connection with FIG. 3. In addition, as shown in FIG. 5, the SMO system 510 may include a Non-RT RIC 525 that may correspond to and/or provide one or more services or functions associated with the Non-RT RIC 250 and/or the Non-RT RIC 338 described in more detail above in connection with FIGS. 2-3, and a RAN NF OAM service 545 that may correspond to and/or provide one or more services or functions associated with the RAN NF OAM service 332 described in more detail above in connection with FIG. 3. In addition, as described herein, the SMO system 510 may include one or more components to facilitate spectrum sharing for the network nodes 550 (e.g., CUs, DUs, and/or RUs) associated with the disaggregated network architecture. The various elements of the SMO system 510 may be communicatively connected via a message bus or fabric 515.

For example, in some aspects, the SMO system 510 may implement a spectrum sharing service 540 as a platform service associated with the SMO system 510 or as a spectrum sharing rApp 530 (e.g., a non-real-time application) managed and executed by the Non-RT RIC 525. For example, in some aspects, the spectrum sharing service 540 may be associated with a secure gateway 535 that may communicate with the spectrum sharing server 505 configured to coordinate communication in shared spectrum (e.g., spectrum that is licensed to an incumbent user or spectrum that is otherwise shared among multiple users). Accordingly, in some aspects, the secure gateway 535 may communicate with the spectrum sharing server 505 to receive spectrum sharing policy information indicating rules, conditions, constraints, and/or other parameters related to communication in the shared spectrum coordinated by the spectrum sharing server 505. The spectrum sharing server 505 may then provide the spectrum sharing policy information to the spectrum sharing rApp 530 and the RAN NF OAM service 545, which may communicate with the one or more network nodes 550 to update configuration parameters to reflect the spectrum sharing policy information. Furthermore, as described herein, the one or more network nodes 550 may be configured to compute and/or collect telemetry information related to communication in the shared spectrum (e.g., interference estimates, spectrum utilization, EIRP estimates, or the like), which may be reported to the SMO system 510 via the RAN NF OAM service 545. The spectrum sharing service 540 may then report the telemetry information to the spectrum sharing server 505 via the secure gateway 535, such that the spectrum sharing server 505 may update the spectrum sharing policy information if needed. Furthermore, although some aspects described herein relate to separating certain functions between the spectrum sharing service 540 and the spectrum sharing rApp 530, the spectrum sharing service 540 that interacts with the spectrum sharing server 505 via the secure gateway 535 may be combined with the spectrum sharing rApp 530 that generates the policies and/or actions to control the network nodes 550.

In some aspects, as described herein, the spectrum sharing server 505 may communicate with the SMO system 510 through the secure gateway 535 to provide spectrum sharing policy information related to communicating in shared spectrum that is coordinated by the spectrum sharing server 505. For example, in some aspects, the spectrum sharing policy information may indicate an EIRP mask associated with an azimuth in a spatial domain (e.g., EIRP limits in spatial directions corresponding to different angles around a horizon), an EIRP mask associated with an elevation in a spatial domain (e.g., EIRP limits in spatial directions corresponding to different angles above the horizon), an EIRP mask in a frequency domain (e.g., EIRP limits applicable to different frequencies within the shared spectrum), and/or an EIRP mask in a time domain (e.g., EIRP limits applicable to different transmission time intervals, such as one or more frames, subframes, slots, or symbols). Furthermore, although the spectrum sharing policy information described herein relates to one or more EIRP masks, the spectrum sharing policy information may specify other suitable rules, conditions, and/or parameters applicable to communication in the shared spectrum (e.g., whether transmission is subject to a channel access mechanism, such as an LBT procedure).

In some aspects, the spectrum sharing policy information received from the spectrum sharing server 505 may be provided to the spectrum sharing rApp 530, which may determine one or more configuration parameters for the one or more network nodes 550 to enforce the spectrum sharing policy information. For example, in cases where the spectrum sharing policy information indicates one or more EIRP masks in the spatial domain (e.g., an azimuthal EIRP mask and/or an elevation EIRP mask), the spectrum sharing rApp 530 may determine one or more information elements to convey the azimuth and elevation information and corresponding EIRP masks to the one or more network nodes 550 (e.g., such that the one or more network nodes 550 can configure an active antenna system or other beamforming hardware to emit energy in different spatial directions in a manner that satisfies the EIRP masks). Additionally, or alternatively, where the spectrum sharing policy information indicates one or more EIRP masks in the frequency domain and/or the time domain, the spectrum sharing rApp 530 may determine one or more physical resource block (PRB) blanking patterns to enforce compliance with the EIRP masks in the frequency domain and/or the time domain. For example, the PRB blanking patterns may include a static PRB blanking pattern and/or a time-varying PRB blanking pattern to indicate one or more PRBs in a time-frequency grid where the one or more network nodes 550 are to emit no energy or a low amount of energy to comply with an EIRP mask in the frequency domain and/or an EIRP mask in the time domain. Furthermore, the spectrum sharing rApp 530 may determine any other suitable configuration parameters to comply with the spectrum sharing policy information received from the spectrum sharing server 505.

In some aspects, the configuration parameters that enforce compliance with the spectrum sharing policy information received from the spectrum sharing server 505 may be provided to one or more DUs included among the one or more network nodes 550. For example, the spectrum sharing rApp 530 may provide the configuration parameters to the RAN NF OAM service 545, which may forward the configuration parameters to the one or more DUs. In some aspects, the one or more DUs may execute distributed applications (dApps) that constrain scheduler operations and/or other configurations to ensure compliance with the spectrum sharing policy information (e.g., scheduling communications in the shared spectrum according to the PRB blanking patterns). In addition, the one or more DUs may provide appropriate configuration parameters to one or more RUs included among the one or more network nodes 550 to ensure compliance with the spectrum sharing policy information. For example, in some aspects, the DUs may provide configuration parameters to the RUs to communicate according to the PRB blanking patterns and/or to control communication hardware to intelligently focus energy in certain spatial directions according to the spatial EIRP masks.

In some aspects, the one or more DUs included among the network nodes 550 may collect and/or compute telemetry information associated with the communication in the shared spectrum. In some aspects, the telemetry information may be stored as a trace or an average over a certain time span, frequency resources, and/or spatial directions. For example, in some aspects, the telemetry information may include an EIRP over an area indicated by the azimuth and elevation information provided by the spectrum sharing service 540, which may also account for any PRBs within the time-frequency grid where EIRP restrictions are applicable in the frequency domain and/or the time domain. Additionally, or alternatively, the telemetry information may relate to signal leakage (e.g., energy that leaks from a direction, a frequency, or a time where communication in the shared spectrum is permitted, to another direction, frequency, or time where communication in the shared spectrum is more constrained). For example, to compute signal leakage, the one or more dApps may be configured to compute one or more precoding vectors for one or more desired users (e.g., one or more UEs), and to form a matrix Hₛ in which columns represent desired signal precoding vectors. The one or more dApps may then compute precoding vectors for one or more nulling directions based on the EIRP masks, and may form a matrix Hₙ in which columns represent the precoding vectors for the desired nulling directions. Accordingly, the dApps may form a channel matrix H=[H¿¿sHₙ]¿ and compute W=H^{H}(H×H^{H}+I)⁻¹, and the columns of W corresponding to the desired signal may be used as precoding vectors. The dApp(s) may then compute a projection of the precoding vectors to the desired nulling directions and include the projection in the telemetry information.

In some aspects, the one or more network nodes 550 (e.g., DUs) may report the telemetry information to the RAN NF OAM service 545, which may provide the telemetry information to the spectrum sharing service 540. In some aspects, the spectrum sharing service 540 may then generate telemetry information in a format consumable by the spectrum sharing server 505 and report the telemetry information to the spectrum sharing server 505 such that the spectrum sharing server 505 can appropriately update the spectrum sharing policy information.

As indicated above, FIG. 5 is provided as an example. Other examples may differ from what is described with respect to FIG. 5.

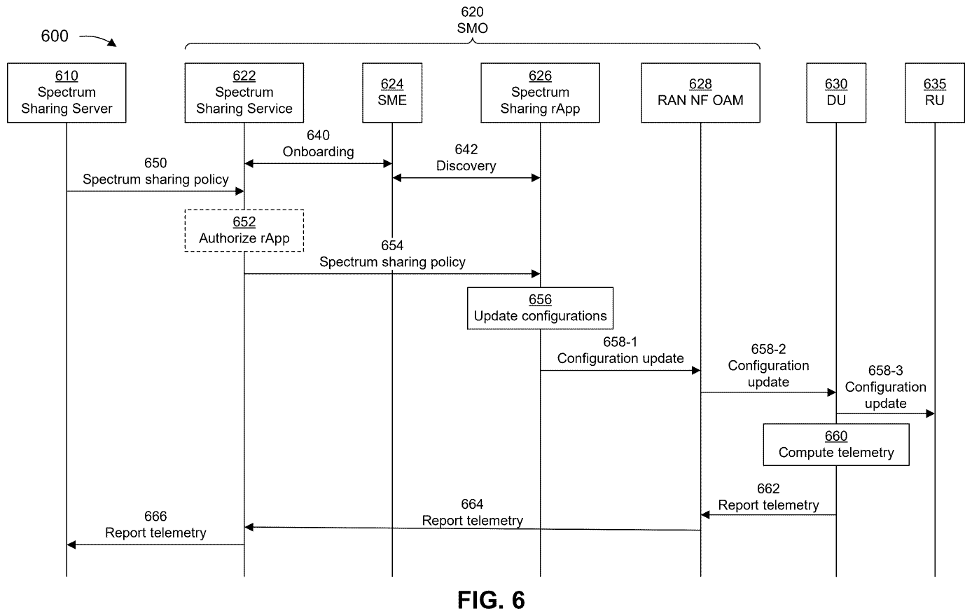

FIG. 6 is a diagram illustrating an example call flow 600 associated with a spectrum sharing service for a disaggregated network architecture, in accordance with the present disclosure. As shown in FIG. 6, example 600 includes communication among a spectrum sharing server 610, an SMO system 620 that includes a spectrum sharing service 622, an SME service 624, a spectrum sharing rApp 626, and a RAN NF OAM service 628, a DU 630, and an RU 635. In some aspects, the spectrum sharing server 610, the SMO system 620, the spectrum sharing service 622, the SME service 624, the spectrum sharing rApp 626, the RAN NF OAM service 628, the DU 630, and the RU 635 may correspond to one or more similar entities described elsewhere herein.

As shown by reference number 640, the spectrum sharing service 622 may communicate with the SME service 624 to perform one or more onboarding operations to configure the spectrum sharing service 622 and the spectrum sharing rApp 626 with the SMO system 620. For example, as shown by reference number 642, the SME service 624 may perform a discovery operation to discover the spectrum sharing rApp 626 and apply any configuration updates, policy updates, topology updates, or other updates to register and onboard the spectrum sharing service 622 and the spectrum sharing rApp 626 (e.g., as described in further detail above with reference to FIG. 3). For example, as described herein, the onboarding and discovery operations may be performed to configure a secure gateway that may communicate with the spectrum sharing server 610, which may coordinate communication in shared spectrum (e.g., spectrum that is licensed to an incumbent user or spectrum otherwise shared among multiple users).

Accordingly, as shown by reference number 650, the spectrum sharing server 610 may communicate with the spectrum sharing service 622 (e.g., through the secure gateway) to provide spectrum sharing policy information related to communicating in shared spectrum. For example, in some aspects, the spectrum sharing policy information may indicate an EIRP mask associated with an azimuth in a spatial domain (e.g., EIRP limits in spatial directions corresponding to different angles around a horizon), an EIRP mask associated with an elevation in a spatial domain (e.g., EIRP limits in spatial directions corresponding to different angles above the horizon), an EIRP mask in a frequency domain (e.g., EIRP limits applicable to different frequencies within the shared spectrum), and/or an EIRP mask in a time domain (e.g., EIRP limits applicable to different transmission time intervals, such as one or more frames, subframes, slots, or symbols). Furthermore, although the spectrum sharing policy information described herein relates to one or more EIRP masks, the spectrum sharing policy information may specify other suitable rules, conditions, and/or parameters applicable to communication in the shared spectrum (e.g., whether transmission is subject to a channel access mechanism, such as an LBT procedure). In some aspects, the spectrum sharing server 610 may provide the spectrum sharing policy information to the spectrum sharing service 622 using a push-based method (e.g., updating the spectrum sharing policy information based on an event) and/or using a pull-based method (e.g., the spectrum sharing policy information is periodically updated and the spectrum sharing service 622 connects to the spectrum sharing server 610 to receive the most recent spectrum sharing policy information).

As further shown by reference number 652, the spectrum sharing service 622 may optionally authorize the spectrum sharing rApp 626 (e.g., may verify that the rApp 626 has been registered with appropriate credentials to access the spectrum sharing policy information). In some aspects, as shown by reference number 654, the spectrum sharing service 622 may provide the spectrum sharing policy information to the spectrum sharing rApp 626 in cases where the spectrum sharing rApp 626 is authorized, and/or in cases where authorization is not needed. In some aspects, the spectrum sharing service 622 may provide the spectrum sharing policy information to the spectrum sharing rApp 626 using a push-based method (e.g., updating the spectrum sharing policy information based on an event, such as a change to the spectrum sharing policy information) and/or using a pull-based method (e.g., the spectrum sharing rApp 626 connects to the spectrum sharing service 622 to receive the most recent spectrum sharing policy information). Additionally, or alternatively, in cases where the spectrum sharing rApp 626 is not authorized, or the spectrum sharing service 622 and the spectrum sharing rApp 626 have a combined implementation, one or more functions described herein as being performed by the spectrum sharing rApp 626 may be performed by the spectrum sharing service 622.

As shown by reference number 656, the spectrum sharing rApp 626 may then determine one or more configuration parameters for the DU 630 and/or the RU 635 to enforce the spectrum sharing policy information. For example, in cases where the spectrum sharing policy information indicates one or more EIRP masks in the spatial domain (e.g., an azimuthal EIRP mask and/or an elevation EIRP mask), the spectrum sharing rApp 626 may determine one or more information elements to convey the azimuth and elevation information and corresponding EIRP masks to the DU 630 and/or the RU 635 (e.g., such that the DU 630 and/or the RU 635 can configure an active antenna system or other beamforming hardware to emit energy in different spatial directions in a manner that satisfies the EIRP masks). Additionally, or alternatively, where the spectrum sharing policy information indicates one or more EIRP masks in the frequency domain and/or the time domain, the spectrum sharing rApp 626 may determine one or more PRB blanking patterns to enforce compliance with the EIRP masks in the frequency domain and/or the time domain. For example, the PRB blanking patterns may include a static PRB blanking pattern and/or a time-varying PRB blanking pattern to indicate one or more PRBs in a time-frequency grid where the DU 630 and/or the RU 635 are to emit no energy or a low amount of energy to comply with an EIRP mask in the frequency domain and/or an EIRP mask in the time domain. Furthermore, the spectrum sharing rApp 626 may determine any other suitable configuration parameters to comply with the spectrum sharing policy information received from the spectrum sharing server 610.

In some aspects, as shown by reference number 658-1, the configuration parameters that enforce compliance with the spectrum sharing policy information may be provided to the RAN NF OAM service 628 (e.g., using a push-based method and/or a pull-based method). For example, the spectrum sharing rApp 626 may provide the configuration parameters to the RAN NF OAM service 628. As shown by reference number 658-2, the RAN NF OAM service 628 may then forward the configuration parameters to the DU 630. In some aspects, the DU 630 may execute one or more dApps that constrain scheduler operations and/or other configurations to ensure compliance with the spectrum sharing policy information (e.g., scheduling communications in the shared spectrum according to the PRB blanking patterns). In addition, as shown by reference number 658-3, the DU 630 may provide appropriate configuration parameters to the RU 635 to ensure compliance with the spectrum sharing policy information. For example, in some aspects, the DU 630 may provide configuration parameters to the RU 635 to configure the RU 635 to communicate according to the PRB blanking patterns and/or to control communication hardware to focus energy in certain spatial directions according to the spatial EIRP masks.

In some aspects, as shown by reference number 660, the DU 630 may collect and/or compute telemetry information associated with the communication in the shared spectrum. For example, the DU 630 may collect performance information from the RU 635 and performance data associated with the DU 630, which may be used to compute the telemetry information. In some aspects, the DU 630 may store the telemetry information as a trace or an average over a certain time span, frequency resources, and/or spatial directions. For example, in some aspects, the telemetry information may include an EIRP over an area indicated by the azimuth and elevation information provided by the spectrum sharing service 622, which may also account for any PRBs within the time-frequency grid where EIRP restrictions are applicable in the frequency domain and/or the time domain. Additionally, or alternatively, the telemetry information may relate to signal leakage (e.g., energy that leaks from a direction, a frequency, or a time where communication in the shared spectrum is permitted, to another direction, frequency, or time where communication in the shared spectrum is more constrained). For example, as described elsewhere herein, the DU 630 may compute a projection of one or more precoding vectors to one or more desired nulling directions and include the projection in the telemetry information. In some aspects, the DU 630 may buffer the telemetry information until the telemetry information is reported (e.g., measurements may be generated at a faster time scale than the resulting telemetry information is reported, such as measurements being generated every 50 milliseconds and the telemetry information being reported every 1 second).

As further shown by reference number 662, the DU 630 may report the telemetry information to the RAN NF OAM service 628 (e.g., using a push-based method and/or a pull-based method). As further shown by reference number 664, the RAN NF OAM service 628 may then provide the telemetry information to the spectrum sharing service 622 (e.g., using a push-based method and/or a pull-based method). In some aspects, as shown by reference number 666, the spectrum sharing service 622 may generate telemetry information in a format consumable by the spectrum sharing server 610 and may report the telemetry information to the spectrum sharing server 610 (e.g., using a push-based method and/or a pull-based method). Accordingly, the spectrum sharing server 610 may then update the spectrum sharing policy information for communicating in the shared spectrum as needed, based on the telemetry information.

As indicated above, FIG. 6 is provided as an example. Other examples may differ from what is described with respect to FIG. 6.

FIG. 7 is a diagram illustrating an example process 700 performed, for example, at a first network node or an apparatus of a first network node, in accordance with the present disclosure. Example process 700 is an example where the apparatus or the first network node (e.g., disaggregated control unit 170, SMO system 260, SMO system 310, disaggregated control unit 430, SMO system 510, SMO system 620, or the like) performs operations associated with a spectrum sharing service for a disaggregated network architecture.

As shown in FIG. 7, in some aspects, process 700 may include receiving, from a second network node, policy information associated with shared spectrum (block 710). For example, the first network node (e.g., using reception component 902 and/or communication manager 906, depicted in FIG. 9) may receive, from a second network node, policy information associated with shared spectrum, as described above.

As further shown in FIG. 7, in some aspects, process 700 may include sending, to a third network node, configuration information that indicates one or more parameters for one or more of a DU or an RU associated with the disaggregated network architecture in accordance with the policy information associated with the shared spectrum (block 720). For example, the first network node (e.g., using communication manager 906, depicted in FIG. 9) may send, to a third network node, configuration information that indicates one or more parameters for one or more of a DU or an RU associated with the disaggregated network architecture in accordance with the policy information associated with the shared spectrum, as described above.

Process 700 may include additional aspects, such as any single aspect or any combination of aspects described below and/or in connection with one or more other processes described elsewhere herein.

In a first aspect, the policy information includes one or more EIRP masks associated with the shared spectrum.

In a second aspect, alone or in combination with the first aspect, the one or more EIRP masks are associated with one or more of a frequency domain, a time domain, an azimuth in a spatial domain, or an elevation in a spatial domain.

In a third aspect, alone or in combination with one or more of the first and second aspects, the one or more parameters are based on one or more of azimuth information or elevation information associated with the one or more EIRP masks in a spatial domain.

In a fourth aspect, alone or in combination with one or more of the first through third aspects, the one or more parameters are based on a PRB blanking pattern associated with the one or more EIRP masks in one or more of a frequency domain or a time domain.

In a fifth aspect, alone or in combination with one or more of the first through fourth aspects, process 700 includes receiving, from the third network node, telemetry information related to communication in the shared spectrum for one or more of the DU or the RU.

In a sixth aspect, alone or in combination with one or more of the first through fifth aspects, process 700 includes sending, to the second network node, the telemetry information related to the communication in the shared spectrum for one or more of the DU or the RU.

In a seventh aspect, alone or in combination with one or more of the first through sixth aspects, the first network node is an SMO system.

In an eighth aspect, alone or in combination with one or more of the first through seventh aspects, the second network node is a server associated with an incumbent user associated with the shared spectrum.

In a ninth aspect, alone or in combination with one or more of the first through eighth aspects, the third network node is the DU, the RU, a CU, a RAN node, or an OAM node.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, at a first network node or an apparatus of a first network node, in accordance with the present disclosure. Example process 800 is an example where the apparatus or the first network node (e.g., network node 110, DU 230, RU 240, RU 352, network nodes 356, RU 415, network nodes 550, DU 630, or RU 635) performs operations associated with a spectrum sharing service for a disaggregated network architecture.

As shown in FIG. 8, in some aspects, process 800 may include receiving, from a second network node, configuration information that indicates one or more parameters in accordance with policy information associated with shared spectrum (block 810). For example, the first network node (e.g., using reception component 1002 and/or communication manager 1006, depicted in FIG. 10) may receive, from a second network node, configuration information that indicates one or more parameters in accordance with policy information associated with shared spectrum, as described above.

As further shown in FIG. 8, in some aspects, process 800 may include communicating in the shared spectrum in accordance with the one or more parameters indicated in the configuration information (block 820). For example, the first network node (e.g., using reception component 1002, transmission component 1004, and/or communication manager 1006, depicted in FIG. 10) may communicate in the shared spectrum in accordance with the one or more parameters indicated in the configuration information, as described above.

Process 800 may include additional aspects, such as any single aspect or any combination of aspects described below and/or in connection with one or more other processes described elsewhere herein.

In a first aspect, the policy information includes one or more EIRP masks associated with the shared spectrum.

In a second aspect, alone or in combination with the first aspect, the one or more EIRP masks are associated with one or more of a frequency domain, a time domain, an azimuth in a spatial domain, or an elevation in a spatial domain.

In a third aspect, alone or in combination with one or more of the first and second aspects, the one or more parameters are based on one or more of azimuth information or elevation information associated with the one or more EIRP masks in a spatial domain.

In a fourth aspect, alone or in combination with one or more of the first through third aspects, the one or more parameters are based on a PRB blanking pattern associated with the one or more EIRP masks in one or more of a frequency domain or a time domain.

In a fifth aspect, alone or in combination with one or more of the first through fourth aspects, process 800 includes sending, to the second network node, telemetry information related to communicating in the shared spectrum.

In a sixth aspect, alone or in combination with one or more of the first through fifth aspects, the first network node is a DU or an RU.

In a seventh aspect, alone or in combination with one or more of the first through sixth aspects, the second network node is an SMO system, a RAN node, an OAM node, a CU, or a DU.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a network node (e.g., an SMO system), or a network node (e.g., an SMO system) may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 185 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 180 described in connection with FIG. 1) of the network node.

In some aspects, the apparatus 900 may be configured to perform one or more operations described herein in connection with FIGS. 5-6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the disaggregated control unit described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 and/or the transmission component 904 may include or may be included in a network interface. The network interface may be configured to obtain and/or output signals for the apparatus 900 via one or more communications links, such as a backhaul link, a midhaul link, and/or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the disaggregated control unit described above in connection with FIG. 1, such as a radio, one or more RF chains, one or more transceivers, or one or more modems, each of which may in turn be coupled with one or more antennas of the disaggregated control unit described in connection with FIG. 1. In some aspects, the transmission component 904 may be co-located with the reception component 902.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive, from a second network node, policy information associated with shared spectrum. The communication manager 906 may send, to a third network node, configuration information that indicates one or more parameters for one or more of a DU or an RU associated with the disaggregated network architecture in accordance with the policy information associated with the shared spectrum.

The reception component 902 may receive, from the third network node, telemetry information related to communication in the shared spectrum for one or more of the DU or the RU.

The communication manager 906 may send, to the second network node, the telemetry information related to the communication in the shared spectrum for one or more of the DU or the RU.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node (e.g., a DU or an RU), or a network node (e.g., a DU or an RU) may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 145 described in connection with FIG. 1) of the network node.

In some aspects, the apparatus 1000 may be configured to perform one or more operations described herein in connection with FIGS. 5-6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the network node described above in connection with FIG. 1, such as a radio, one or more RF chains, one or more transceivers, or one or more modems, each of which may in turn be coupled with one or more antennas of the network node. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, from a second network node, configuration information that indicates one or more parameters in accordance with policy information associated with shared spectrum. The reception component 1002 and/or the transmission component 1004 may communicate in the shared spectrum in accordance with the one or more parameters indicated in the configuration information.

The communication manager 1006 may send, to the second network node, telemetry information related to communicating in the shared spectrum.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a first network node associated with a disaggregated network architecture, comprising: receiving, from a second network node, policy information associated with shared spectrum; and sending, to a third network node, configuration information that indicates one or more parameters for one or more of a DU or an RU associated with the disaggregated network architecture in accordance with the policy information associated with the shared spectrum.

Aspect 2: The method of Aspect 1, wherein the policy information includes one or more EIRP masks associated with the shared spectrum.

Aspect 3: The method of Aspect 2, wherein the one or more EIRP masks are associated with one or more of a frequency domain, a time domain, an azimuth in a spatial domain, or an elevation in a spatial domain.

Aspect 4: The method of Aspect 2, wherein the one or more parameters are based on one or more of azimuth information or elevation information associated with the one or more EIRP masks in a spatial domain.

Aspect 5: The method of Aspect 2, wherein the one or more parameters are based on a PRB blanking pattern associated with the one or more EIRP masks in one or more of a frequency domain or a time domain.

Aspect 6: The method of any of Aspects 1-5, further comprising: receiving, from the third network node, telemetry information related to communication in the shared spectrum for one or more of the DU or the RU.

Aspect 7: The method of Aspect 6, further comprising: sending, to the second network node, the telemetry information related to the communication in the shared spectrum for one or more of the DU or the RU.

Aspect 8: The method of any of Aspects 1-7, wherein the first network node is an SMO system.

Aspect 9: The method of any of Aspects 1-8, wherein the second network node is a server associated with an incumbent user associated with the shared spectrum.

Aspect 10: The method of any of Aspects 1-9, wherein the third network node is the DU, the RU, a CU, a RAN node, or an OAM node.

Aspect 11: A method of wireless communication performed by a first network node associated with a disaggregated network architecture, comprising: receiving, from a second network node, configuration information that indicates one or more parameters in accordance with policy information associated with shared spectrum; and communicating in the shared spectrum in accordance with the one or more parameters indicated in the configuration information.

Aspect 12: The method of Aspect 11, wherein the policy information includes one or more EIRP masks associated with the shared spectrum.

Aspect 13: The method of Aspect 12, wherein the one or more EIRP masks are associated with one or more of a frequency domain, a time domain, an azimuth in a spatial domain, or an elevation in a spatial domain.

Aspect 14: The method of Aspect 12, wherein the one or more parameters are based on one or more of azimuth information or elevation information associated with the one or more EIRP masks in a spatial domain.

Aspect 15: The method of Aspect 12, wherein the one or more parameters are based on a PRB blanking pattern associated with the one or more EIRP masks in one or more of a frequency domain or a time domain.

Aspect 16: The method of any of Aspects 11-15, further comprising: sending, to the second network node, telemetry information related to communicating in the shared spectrum.

Aspect 17: The method of any of Aspects 11-16, wherein the first network node is a DU or an RU.

Aspect 18: The method of any of Aspects 11-17, wherein the second network node is an SMO system, a RAN node, an OAM node, a CU, or a DU.

Aspect 19: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-18.

Aspect 20: An apparatus for wireless communication at a device, the apparatus comprising one or more memories and one or more processors coupled to the one or more memories, the one or more processors configured to cause the device to perform the method of one or more of Aspects 1-18.

Aspect 21: An apparatus for wireless communication, the apparatus comprising at least one means for performing the method of one or more of Aspects 1-18.

Aspect 22: A non-transitory computer-readable medium storing code for wireless communication, the code comprising instructions executable by one or more processors to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

Aspect 24: A device for wireless communication, the device comprising a processing system that includes one or more processors and one or more memories coupled with the one or more processors, the processing system configured to cause the device to perform the method of one or more of Aspects 1-18.

Aspect 25: An apparatus for wireless communication at a device, the apparatus comprising one or more memories and one or more processors coupled to the one or more memories, the one or more processors individually or collectively configured to cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A first network node for wireless communication, comprising:
one or more memories; and
one or more processors, coupled to the one or more memories, configured to cause the first network node to:
receive, from a second network node, policy information associated with shared spectrum; and
send, to a third network node, configuration information that indicates one or more parameters for one or more of a distributed unit (DU) or a radio unit (RU) associated with a disaggregated network architecture in accordance with the policy information associated with the shared spectrum.

2. The first network node of claim 1, wherein the policy information includes one or more effective isotropic radiated power (EIRP) masks associated with the shared spectrum.

3. The first network node of claim 2, wherein the one or more EIRP masks are associated with one or more of a frequency domain, a time domain, an azimuth in a spatial domain, or an elevation in a spatial domain.

4. The first network node of claim 2, wherein the one or more parameters are based on one or more of azimuth information or elevation information associated with the one or more EIRP masks in a spatial domain.

5. The first network node of claim 2, wherein the one or more parameters are based on a physical resource block (PRB) blanking pattern associated with the one or more EIRP masks in one or more of a frequency domain or a time domain.

6. The first network node of claim 1, wherein the one or more processors are further configured to cause the first network node to:
receive, from the third network node, telemetry information related to communication in the shared spectrum for one or more of the DU or the RU.

7. The first network node of claim 6, wherein the one or more processors are further configured to cause the first network node to:
send, to the second network node, the telemetry information related to the communication in the shared spectrum for one or more of the DU or the RU.

8. The first network node of claim 1, wherein the first network node is a service management and orchestration (SMO) node.

9. The first network node of claim 1, wherein the second network node is a server associated with an incumbent user associated with the shared spectrum.

10. The first network node of claim 1, wherein the third network node is the DU, the RU, a central unit (CU), a radio access network (RAN) node, or an operations, administration, and maintenance (OAM) node.

11. A first network node for wireless communication, comprising:
one or more memories; and
one or more processors, coupled to the one or more memories, configured to cause the first network node to:
receive, from a second network node, configuration information that indicates one or more parameters in accordance with policy information associated with shared spectrum; and
communicate in the shared spectrum in accordance with the one or more parameters indicated in the configuration information.

12. The first network node of claim 11, wherein the policy information includes one or more effective isotropic radiated power (EIRP) masks associated with the shared spectrum.

13. The first network node of claim 12, wherein the one or more EIRP masks are associated with one or more of a frequency domain, a time domain, an azimuth in a spatial domain, or an elevation in a spatial domain.

14. The first network node of claim 12, wherein the one or more parameters are based on one or more of azimuth information or elevation information associated with the one or more EIRP masks in a spatial domain.

15. The first network node of claim 12, wherein the one or more parameters are based on a physical resource block (PRB) blanking pattern associated with the one or more EIRP masks in one or more of a frequency domain or a time domain.

16. The first network node of claim 11, wherein the one or more processors are further configured to cause the first network node to:
send, to the second network node, telemetry information related to communicating in the shared spectrum.

17. The first network node of claim 11, wherein the first network node is a distributed unit (DU) or a radio unit (RU).

18. The first network node of claim 11, wherein the second network node is a service management and orchestration (SMO) node, a radio access network (RAN) node, an operations, administration, and maintenance (OAM) node, a central unit (CU), or a distributed unit (DU).

19. A method of wireless communication performed by a first network node associated with a disaggregated network architecture, comprising:
receiving, from a second network node, policy information associated with shared spectrum; and
sending, to a third network node, configuration information that indicates one or more parameters for one or more of a distributed unit (DU) or a radio unit (RU) associated with the disaggregated network architecture in accordance with the policy information associated with the shared spectrum.

20. The method of claim 19, wherein the policy information includes one or more effective isotropic radiated power (EIRP) masks associated with the shared spectrum.

21. The method of claim 20, wherein the one or more EIRP masks are associated with one or more of a frequency domain, a time domain, an azimuth in a spatial domain, or an elevation in a spatial domain.

22. The method of claim 20, wherein the one or more parameters are based on one or more of azimuth information or elevation information associated with the one or more EIRP masks in a spatial domain.

23. The method of claim 20, wherein the one or more parameters are based on a physical resource block (PRB) blanking pattern associated with the one or more EIRP masks in one or more of a frequency domain or a time domain.

24. The method of claim 19, further comprising:
receiving, from the third network node, telemetry information related to communication in the shared spectrum for one or more of the DU or the RU.

25. The method of claim 24, further comprising:
sending, to the second network node, the telemetry information related to the communication in the shared spectrum for one or more of the DU or the RU.

26. The method of claim 19, wherein the method is a service management and orchestration (SMO) node.

27. The method of claim 19, wherein the second network node is a server associated with an incumbent user associated with the shared spectrum.

28. The method of claim 19, wherein the third network node is the DU, the RU, a central unit (CU), a radio access network (RAN) node, or an operations, administration, and maintenance (OAM) node.

29. A method for wireless communication performed by a first network node associated with a disaggregated network architecture, comprising:
receiving, from a second network node, configuration information that indicates one or more parameters in accordance with policy information associated with shared spectrum; and
communicating in the shared spectrum in accordance with the one or more parameters indicated in the configuration information.

30. The method of claim 29, wherein the policy information includes one or more effective isotropic radiated power (EIRP) masks associated with the shared spectrum in one or more of a frequency domain, a time domain, an azimuth in a spatial domain, or an elevation in a spatial domain.
